(19) United States
(12) Patent Application Publication
(10) Pub. No.: US 2019/0331094 A1
(43) Pub. Date: Oct. 31, 2019

(54) MEASURING ELECTRICAL CHARACTERISTICS OF A TRANSDUCER IN A WIND TURBINE GENERATOR

(71) Applicant: VESTAS WIND SYSTEMS A/S, Aarhus N (DK)

(72) Inventors: Lars Rohrmann ANDERSEN, Hadsten (DK); John BENGTSON, Århus C (DK); Karl Axel PETURSSON, Hadsten (DK)

(21) Appl. No.: 16/472,969

(22) PCT Filed: Dec. 12, 2017
(86) PCT No.: PCT/DK2017/050420

§ 371 Date: Jun. 24, 2019

(30) Foreign Application Priority Data
Dec. 22, 2016 (DK) PA 2016 71035

(51) Int. Cl. F03D 17/00

(52) U.S. Cl. CPC F03D 17/00; F05B 2270/80; F05B 2270/708; F05B 2260/80

(57) ABSTRACT

A method of measuring electrical characteristics of a transducer in a wind turbine generator control system is described. The method comprises measuring one or more electrical characteristics of a transducer of the control system, and comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.

### FIELD OF THE INVENTION

The present invention relates to a method and apparatus for measuring electrical characteristics of a transducer in a wind turbine generator.

### BACKGROUND TO THE INVENTION

A typical wind turbine comprise a fixed tower which stands on the ground or sea bed, and a nacelle which rests on the top of the tower and carries a turbine shaft, a gearbox, a brake, a generator, a blade pitch controller which controls the angle of the turbine blades, and yaw drives which control the position of the wind turbine relative to the wind. Turbine blades are mounted to the turbine shaft externally of the nacelle. The turbine blades cause the shaft to rotate under the influence of wind, which in turn drives the generator to generate electrical power.

The overall operation of a wind turbine is controlled by a control system. The control system comprises sensors for determining the current status of the turbine equipment and operation, and the local environment, a processor for handling the outputs of those sensors, and actuators for controlling turbine operation. It will be appreciated that the sensors and actuators (transducers) may fail completely, become faulty, or generally degrade over time. The diagnosis of faults with sensors and actuators typically requires knowledge of expected characteristics for these sensors and actuators, so that diagnostic measurements can be compared with expected characteristics.

It is against this background that the invention has been devised.

### SUMMARY OF THE INVENTION

In a first aspect, the invention provides a method of measuring electrical characteristics of a transducer in a wind turbine generator control system, the method comprising:

measuring one or more electrical characteristics of a transducer of the control system; and
comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.

In this way, more accurate diagnosis for faults with transducers can be achieved, since the reference characteristics against which the measured electrical characteristics are compared can be more bespoke to the environment in which the transducer is used. For example, where the reference characteristics is a previously measured electrical characteristic of that particular transducer, then such a reference has been obtained in situ and thus is appropriate having regard to the wind turbine generator and control system in which it is installed. On the other hand, for reference characteristics stored in a database, and/or based on measurements taken from other similar wind turbine generators, the reference values can be updated based on experience of that transducer elsewhere in similar environments. In the case of a database, this may enable the retrieval of reference characteristics based on the specific function and environment (e.g. the wind turbine generator and its control system) in which the transducer is located.

The electrical characteristics may comprise a current level through the transducer and/or the electrical characteristics comprise a test signal response of a signal path through the transducer.

The method may comprise generating a fault event if the comparison identifies that the measured electrical characteristics deviate from the reference electrical characteristics by more than a threshold amount.

The measured electrical characteristics may be stored locally and/or to an external database.

The method may comprise generating diagnostic information representing trends in the measured electrical characteristics over time.

Where the reference electrical characteristics are stored in a database, the method may comprise obtaining the reference electrical characteristics from the database and storing them locally.

Where the reference electrical characteristics comprise previously measured electrical characteristics of an identical or similar transducer in another wind turbine, the method may comprise maintaining a database of measured electrical characteristics of transducers in wind turbine generators. Then, if the transducer of the control system suffers a fault, the method comprises identifying from the database similar transducers which have similar electrical characteristics as the faulty transducer.

Candidate reference electrical characteristics may be stored in association with one or more of transducer age, turbine type, and the control system role of the transducer, and the reference electrical characteristics for comparison with the measured electrical characteristics may be selected from the candidate reference electrical characteristics in dependence on one or more of the age of the transducer of the control system, the role of the transducer in the control system, and the turbine type of the wind turbine generator in which the control system is installed.

In a second aspect, the invention provides a diagnostic apparatus for measuring electrical characteristics of a transducer in a wind turbine generator control system, the apparatus comprising:
a measurement device, for measuring one or more electrical characteristics of a transducer of the control system; and
a controller, for comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.

The controller may be responsive to the comparison identifying that the measured electrical characteristics deviate from the reference electrical characteristics by more than a threshold amount to generate a fault event.

Other aspects of the invention include a wind turbine control system comprising the diagnostic apparatus set out above, a wind turbine generator comprising such a wind turbine control system, and a computer program product carrying a computer program for performing the above method.

Generally, the present techniques apply equally to both sensors and actuators as forms of transducer. Accordingly, these terms are often used interchangeably herein.

### BRIEF DESCRIPTION OF THE DRAWINGS

FIG. 1 is a schematic drawing of a wind turbine generator;

FIGS. 2A, 2B, 2C and 2D are schematic drawings of sensor control and diagnosis systems; and

FIG. 3 is a schematic flow diagram of a sensor test method for use with FIG. 2A; and

FIG. 4 is a schematic flow diagram of a sensor test method for use with any of FIG. 2B, 2C or 2D.

### DETAILED DESCRIPTION OF EMBODIMENTS OF THE INVENTION

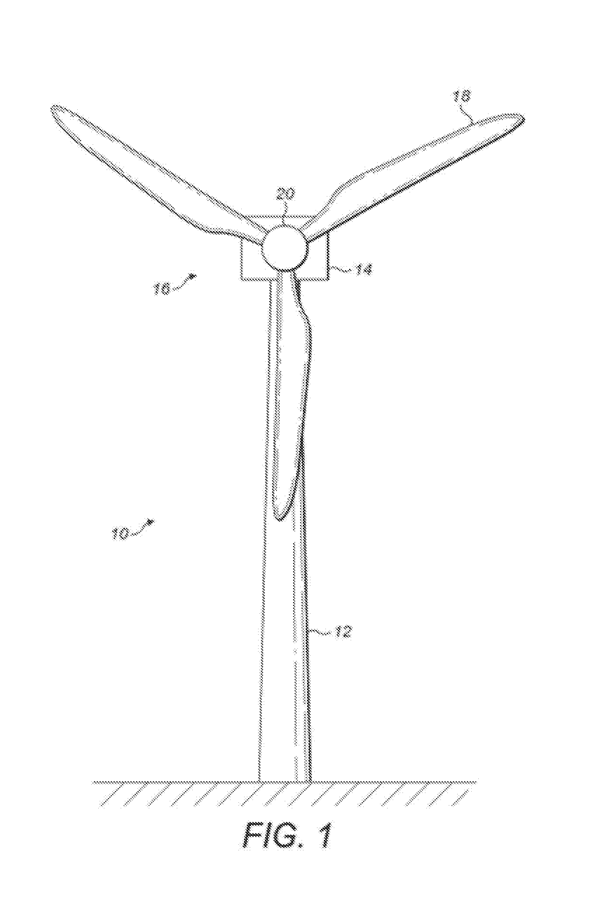

FIG. 1 shows a wind turbine 10 comprising a tower 12 supporting a nacelle 14 to which a rotor 16 is mounted. The rotor 16 comprises a plurality of wind turbine blades 18 that extend radially from a central hub 20. In this example, the rotor 16 comprises three blades 18. As discussed above, the pitch (angle of attack with respect to the wind) of the wind turbine blades 18 can be adjusted by a blade pitch controller (not shown), while the yaw of the nacelle 14 can be adjusted by a yaw drive (not shown) to face generally into the wind. The rotor 16 is mounted on a main bearing (not shown), which permits the rotor to rotate freely about its axis. The wind turbine blades 18 are each mounted to the rotor via blade bearings (not shown), which permit the blade 18 to rotate about their longitudinal axis to adjust their pitch. It will be understood that many such wind turbines can be established in a site, or wind farm, covering an area of several square kilometres.

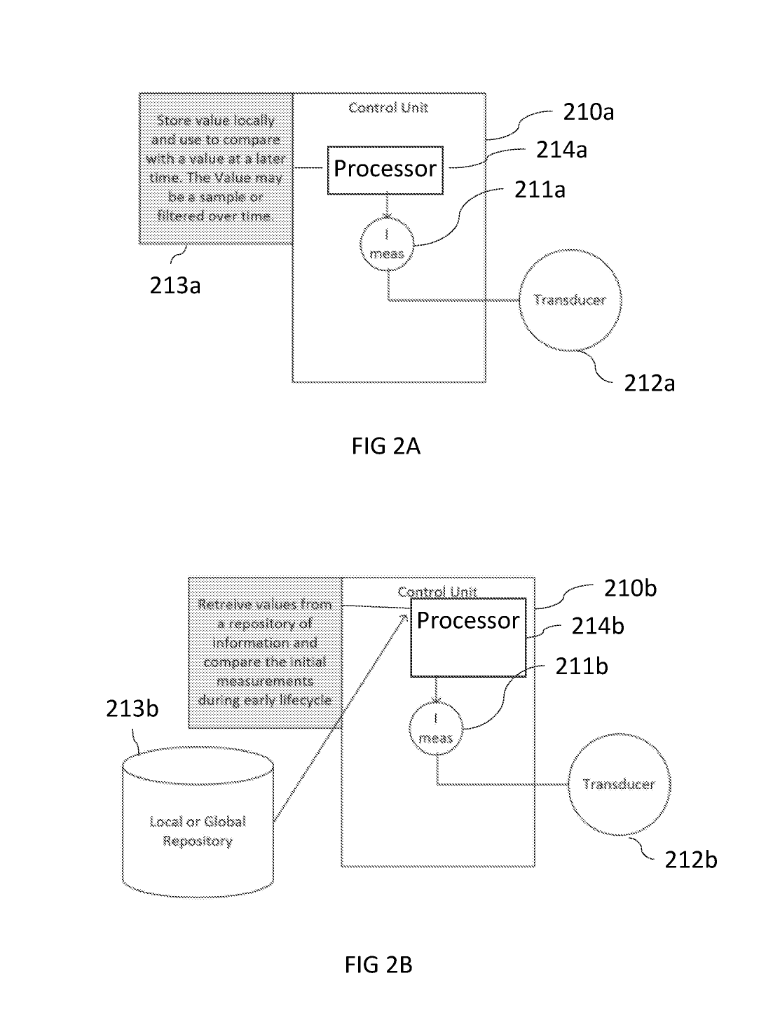

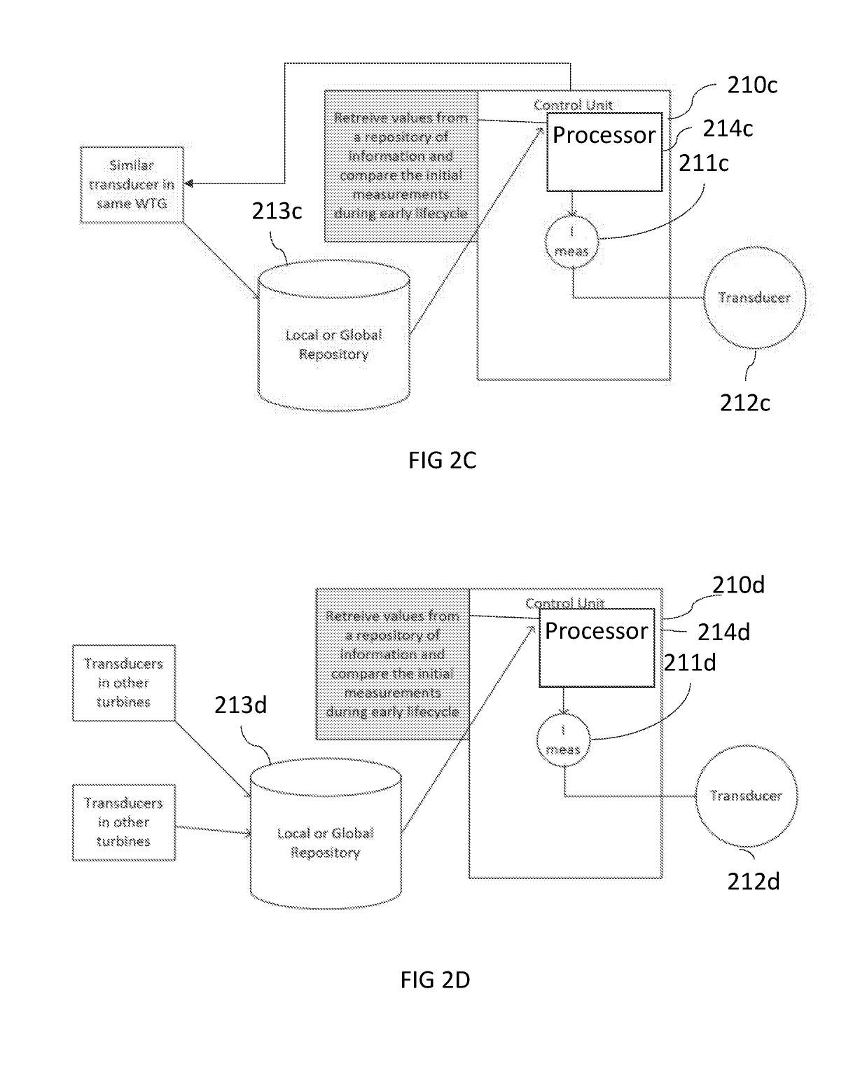

The overall operation of the wind turbine 10 is controlled by a control system. Part of such a control system is shown in each of FIGS. 2A to 2D. Each of FIGS. 2A to 2D set out an example control system, but in each case the data used to set reference electrical characteristics for fault diagnosis is obtained differently. In practice, it will be understood that a wind turbine generator control system will include many components, including a large number of transducers (sensors and actuators), processing circuitry and software. For the purposes of explaining the present technique, only those components directly concerned are shown in the Figures. Moreover, only a single transducer is shown, whereas in practice the present techniques would be applied in parallel to many sensors of the wind turbine generator control system.

In FIG. 2A, a control unit 210a comprises a current measurement device 211a, which measures the current passing through a transducer 212a. The control unit 210a comprises a processor 214a which has access to a local data store 213a, at which a previously measured current level of the transducer 212a has been stored by the processor 214a. The processor 214a is able to access previous current measurement data from the store 213a, and compare it with newly measured current data from the current measurement device 211a. Based on the result of the comparison, the processor 214a may take no action, may update the current measurement information in the data store 213a, may generate a fault alert, or may trigger the sensor and/or the control system and wind turbine generator as a whole to shut down. The comparison may be to determine if the newly measured current from the current measurement device 211a is within an acceptable range defined with respect to the stored previously measured current level. It will be appreciated that, in addition to (or instead of) the previously measured current level, an acceptable current range may be stored, in which case the comparison carried out by the processor 214a will be to determine whether the newly measured current is within the stored range. It will also be appreciated that the stored current level (or range) may be an averaged current level (or range) based on multiple previous measurements of the current through the transducer 212a. In some cases the local data store 213a may store several historic measurement values, making it possible for an engineer or a diagnostics tool to view current level trends of the transducer 212a over time (which might indicate degradation of the sensor). It will be appreciated that the processor 214a will typically have both read access (to read current measurements for comparison with new measurements) and write access (to store both original and new current measurements) to the local data store 213a. The processor 214a may process measurements (for example to generate a range, or compute an averaged measurement value), and then store the processed data, or may simply store measurements.

By comparing older current measurement information to current information, a transducer may be diagnosed as worn or defective. To enable this function, current measurements are stored and continuously compared with historical data.

In FIG. 2B, a control unit 210b comprises a current measurement device 211b, which measures the current passing through a transducer 212b. The control unit 210b comprises a processor 214b which has access to a local or global data store (repository or database) 213b, within which reference current levels of the transducer 212b are stored. The processor 214b is able to access the reference current data from the repository 213b, and compare it with measured current data from the current measurement device 211b. Based on the result of the comparison, the processor 214b may take no action, may generate a fault alert, or may trigger the sensor and/or the control system and wind turbine generator as a whole to shut down. The comparison may be to determine if the measured current from the current measurement device 211b is within an acceptable range defined with respect to the reference current level. It will be appreciated that, in addition to (or instead of) the reference current level, an acceptable current range may be stored, in which case the comparison carried out by the processor 214b will be to determine whether the measured current is within the range obtained from the repository. It will be appreciated that the example of FIG. 2B is particularly beneficial during the early lifecycle of the control system, when previous current measurements for that sensor in that control system are not available.

It will be understood from the above that the database/repository 213b can store standardised current values, which can be dynamically updated centrally so that diagnostics are always being carried out based on the most up to date reference information. To give a set of values to start comparing with, transducer information gathered into a central database will enable a comparative calculation early in the turbines lifecycle. If required, the baseline information can be stored in the turbine control system locally. This technique may be used for preventive maintenance, fault finding, start-up procedure or production tests.

Referring to FIG. 2C, this is similar to FIG. 2B, except that the repository stores actual previously measured current levels (or reference values derived from actual current levels) of that transducer. The current operation of a control unit 210c, a current measurement device 211c, a transducer 212c and a local or global repository 213c are substantially as described above in relation to FIG. 2B. However, in this case a processor 214c provides current measurement data to the repository 213c (potentially via a third-party device or service). As a result, during early lifecycle reference values can be used (since actual local measurements are not available), and subsequently actual previous current measurements can be used (similarly to FIG. 2A). To enable this technique, the control system may store data locally and report any differences from historical data. During service scenarios, the information can be shown as differences or trends from one service visit to the next. Values may be stored in a central database to relieve the control system of load, and comparative values can be retrieved from there as required.

Referring to FIG. 2D, this is similar to FIG. 2C, except that the repository stores actual previously measured current levels (or reference values derived from actual current levels) of the same or similar transducers in other wind turbine generators. The current operation of a control unit 210d, a current measurement device 211d, a transducer 212d and a local or global repository 213d are substantially as described above in relation to FIG. 2C. However, in this case the processors (for example the processor 214d) of a number of wind turbine generators provide current measurement data for updating the repository 213d. As a result, even early life-cycle testing can be carried out based on actual measurement data—in this case from the same or similar transducers in the same or a similar type of wind turbine generator/control system. It will be appreciated that as more and more in-service current measurement information is used to update the repository 213d, the reference current information can be expected to become more accurate and robust. In particular, comparing measurements of current on individual transducers to a set of measurements from one or more other turbines will show how the transducer is performing compared to a larger set of individual transducers in a turbine fleet. For example, the “baseline” reference current may actually be statistical data for a large number of that particular sensor derived from measurements taken at multiple wind turbines. This may for example provide an expected average current consumption for the sensor in that application and an associated normal distribution. The processor 214d is then able to determine whether a new local current measurement for a particular sensor is outside acceptable limits on the normal distribution curve for that sensor type.

For FIGS. 2B, 2C and 2D, the database may store a unique sensor identifier which makes it possible to identify where the sensor is used. This is because the sensor current consumption may vary depending on the actual use of the sensor. An average current value and an associated acceptable range may be stored for each sensor and/or sensor type. The age of a particular sensor could also be stored, where the performance could be expected to degrade with the age of the sensor. Candidate reference electrical characteristics are stored in association with one or more of transducer age, turbine type, and control system role. The reference electrical characteristics for comparison with the measured electrical characteristics are selected from the candidate reference electrical characteristics in dependence on one or more of the age of the transducer of the control system, the role of the transducer in the control system, and the turbine type of the wind turbine generator in which the control system is installed.

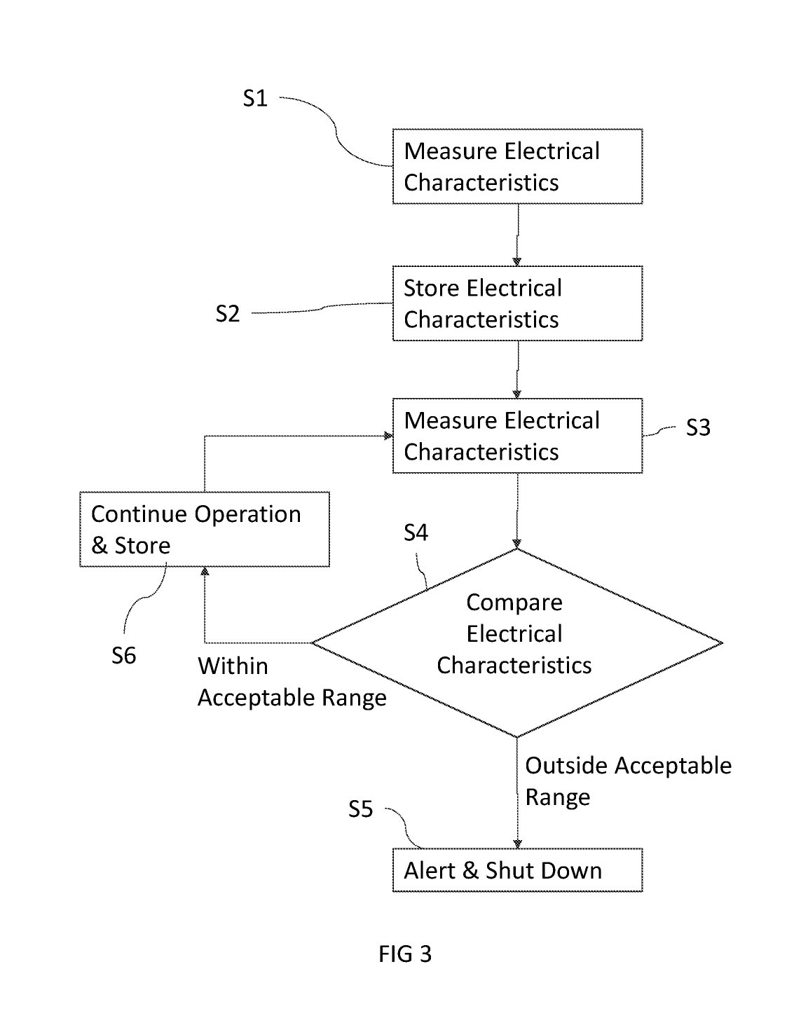

Referring to FIG. 3, a method of operating the apparatus of FIG. 2A is shown. At a step S1, the electrical characteristics of a transducer are measured for the first time to give a baseline level, and then stored at a step S2. At a later time (testing could be carried out periodically, or on demand) a new measurement of the electrical characteristics of that transducer are measured at a step S3. At a step S4, the new measurement and the stored measurement are compared. If the new measurement is outside of an acceptable range (or in other words deviated from the previous measurement by more than a threshold amount) defined with reference to the baseline measurement, then at a step S5 a fault alert or event may be generated and the sensor and optionally the wind turbine generator may be shut down. If at the step S4 it is determined that the new measurement is within the acceptable range then at a step S6 sensor and wind turbine generator operation continues, and the new electrical characteristic measurement may optionally be stored. The process then returns to the step S3, forming a loop. It will be understood that the storage part of the step S6 may store the new measurement value to provide subsequent access to historical trends of a series of measurements, or the new measurement value may be used to modify the reference value for the electrical characteristic (for example by averaging).

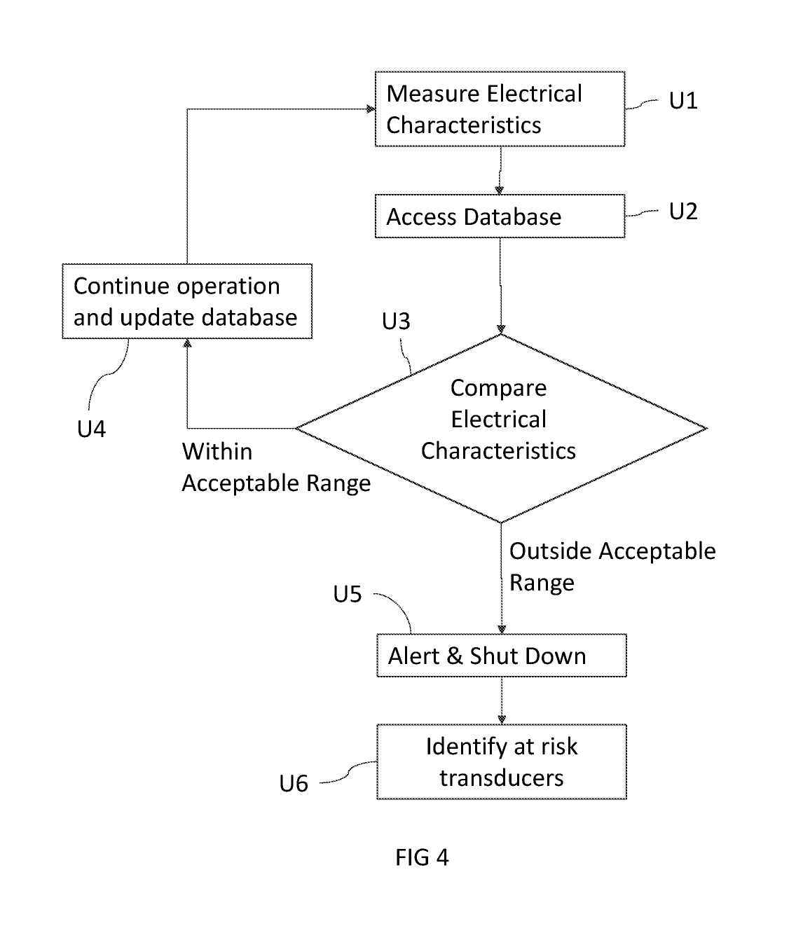

Referring to FIG. 4, a method of operating the apparatus of FIGS. 2B, 2C and 2D is shown. At a step U1, the electrical characteristics of a transducer are measured. At a step U2, a database/repository is accessed to obtain reference electrical characteristics, either for that particular sensor, or that type of sensor within the same or similar type of wind turbine generator. At a step U3, the measured electrical characteristics are compared with the reference electrical characteristics obtained from the database/repository, to determine if the measured characteristics deviate from the reference electrical characteristics by more than a threshold amount. If the comparison reveals that the measured electrical characteristics are within the acceptable range, then at a step U4 turbine and sensor operation are continued, and the database/repository is updated with the new measurement. If the comparison reveals that the measured electrical characteristics are outside of an acceptable range, then at a step U5 a fault alert or event will be generated and the sensor and optionally the wind turbine generator will be shut down. It will be appreciated that the same database is accessible to the control systems of multiple wind turbine generators. If each of these control systems is operating in accordance with the procedure described in FIG. 4, the step U4 will serve to continuously refine the database using new measurements, improving the robustness of the reference data for future comparisons. Following the step U5, at a step U6 (which occurs only if the transducer of the control system suffers a fault), the control system (or an external device) identifies from the database similar transducers which have similar electrical characteristics as the faulty transducer. In other words, when a transducer fails, it is possible to look at its most recent electrical characteristics (or historical trends in those characteristics if these are stored in the database) and then compare these with other similar transducers operating in similar environments (such as similar turbines and/or performing similar functions). Any other transducers identified as having similar electrical characteristics may then be either deactivated as a precaution, or subject to an early service and/or replacement.

In either the method of FIG. 3, or the method of FIG. 4, as measurements are made, they can be stored (locally or centrally), and then used to generate diagnostic information representing trends in the measured electrical characteristics over time. In database implementations, the database can be interrogated by a data processing apparatus, and the obtained data subject to data processing to identify trends, which in turn can be used to improve the quality of the database if required. For example, if a particular sensor type is regularly failing soon after being measured with a particular current level, the reference current level might be modified to trigger an alert and shutdown more readily.

While in the above examples the electrical characteristics which are measured, stored and used for comparison purposes are current levels through transducers, the same principles can be applied to other electrical characteristics. For example, it is known to inject a test signal on a signal path through the transducer and measure the response. Previously measured or derived test signal responses may be used in the same manner as described above for current measurements.

While embodiments of the invention have been shown and described, it will be understood that such embodiments are described by way of example only and it will be appreciated that features of different embodiments may be combined with one another. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method of measuring electrical characteristics of a transducer in a wind turbine generator control system, the method comprising:
measuring one or more electrical characteristics of a transducer of the control system; and
comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.

2. A method according to claim 1, wherein the electrical characteristics comprise a current level through the transducer.

3. A method according to claim 1, wherein the electrical characteristics comprise a test signal response of a signal path through the transducer.

4. A method according to claim 1, comprising generating a fault event if the comparison identifies that the measured electrical characteristics deviate from the reference electrical characteristics by more than a threshold amount.

5. A method according to claim 1, comprising storing the measured electrical characteristics locally.

6. A method according to claim 1, comprising storing the measured electrical characteristics to an external database.

7. A method according to claim 1, comprising generating diagnostic information representing trends in the measured electrical characteristics over time.

8. A method according to claim 1, wherein the reference electrical characteristics are stored in a database, the method comprising obtaining the reference electrical characteristics from the database and storing them locally.

9. A method according to claim 1, wherein the reference electrical characteristics comprise previously measured electrical characteristics of an identical or similar transducer in another wind turbine, the method comprising maintaining a database of measured electrical characteristics of transducers in wind turbine generators, and wherein if the transducer of the control system suffers a fault, the method comprises identifying from the database similar transducers which have similar electrical characteristics as the faulty transducer.

10. A method according to claim 1, wherein candidate reference electrical characteristics are stored in association with one or more of transducer age, turbine type, and the role of the transducer in the control system, and the reference electrical characteristics for comparison with the measured electrical characteristics are selected from the candidate reference electrical characteristics in dependence on one or more of the age of the transducer of the control system, the role of the transducer in the control system and the turbine type of the wind turbine generator in which the control system is installed.

11. A diagnostic apparatus for measuring electrical characteristics of a transducer in a wind turbine generator control system, the apparatus comprising:
a measurement device, for measuring one or more electrical characteristics of a transducer of the control system; and
a controller, for comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.

12. A diagnostic apparatus according to claim 11, wherein the controller is responsive to the comparison identifying that the measured electrical characteristics deviate from the reference electrical characteristics by more than a threshold amount to generate a fault event.

13. (canceled)

14. (canceled)

15. (canceled)

16. A system, comprising:
a wind turbine, comprising:
a tower;
a nacelle disposed on the tower;
a generator disposed in the nacelle;
a rotor mechanically coupled to the generator and extending from the nacelle;
a plurality of blades disposed at a distal end of the rotor; and
a control system comprising a transducer disposed in the generator; and
an apparatus for measuring electrical characteristics of the transducer, the apparatus comprising:
a measurement device, for measuring one or more electrical characteristics of the transducer; and
a controller, for comparing the measured electrical characteristics to one or more reference electrical characteristics, the reference electrical characteristics being one of (a) previously measured electrical characteristics of that transducer, (b) reference electrical characteristics stored in a database, and (c) previously measured electrical characteristics of an identical or similar transducer in another wind turbine generator.
